(19) United States
(12) Patent Application Publication
(10) Pub. No.: US 2024/0342839 A1
(43) Pub. Date: Oct. 17, 2024

(54) Clamp Arrangement And Precision Alignment Mechanism For Tube Welding Machines

(71) Applicant: Terumo BCT, Inc., Lakewood, CO (US)

(72) Inventors: Filip PAEPS, Leefdaal (BE); Bijesh THODUVAYIL, Thiruvananthapuram (IN); Bravish BABU M, Thiruvananthapuram (IN); Shinu NAIR, Kerela (IN); Maarten ROELANDT, Kapellen (BE); Lucas VANDEKERCKHOVE, Heverlee (BE); Joachim BORTELS, Sint-Truiden (BE)

(21) Appl. No.: 18/616,872

(22) Filed: Mar. 26, 2024

Related U.S. Application Data
(60) Provisional application No. 63/459,065, filed on Apr. 13, 2023.

(51) Int. Cl. B23K 37/04

(52) U.S. Cl. CPC B23K 37/0435

(57) ABSTRACT

A tube clamp arrangement includes a first mounting plate and a second mounting plate. The first mounting plate is configured to join together a first tube-holding assembly and a first adjustment mechanism, where the first adjustment mechanism is configured to move in a first direction in a first plane. The second mounting plate is configured to join together a second tube-holding assembly and a second adjustment mechanism, where the second adjustment mechanism is configured to move in a second direction in the first plane.

### CROSS-REFERENCE TO RELATED APPLICATIONS

This application claims the benefit of U.S. Provisional Application No. 63/459,065 filed Apr. 13, 2023. The entire disclosure of the above application is incorporated herein by reference.

### FIELD

The present disclosure relates to clamp arrangements and precision alignment mechanisms for tube welding machines.

### BACKGROUND

This section provides background information related to the present disclosure which is not necessarily prior art.

Tube welding machines (also referred to as tube welding devices) are used for connecting closed end tubes which are often connected to bags or similar containers carrying, for example, blood or blood components. Tube welding devices commonly include first and second tube-holding assemblies (e.g., first and second clamps) configured to receive first and second tubes and a space between the first and second tube-holding assemblies configured to receive a wafer (e.g., heated blade), where the tubing welding device is configured to send energy to the space such that the wafer can be heated to desired temperatures. A process used in conjunction with a tubing welding device may include sending energy to the wafer to heat the wafer to a desired temperature and urging the heated wafer into contact with each tube held by the tube-holding assemblies so as to temporarily sealing together opposing surfaces of the respective tubes and creating molten tube ends. At least a portion of one or both of the first and second tube-holding assemblies may then be moved to align and join together the molten tube ends of the first and second tubes. The joint may be cooled and subjected to a stress so as to open the temporary seals providing fluid communication between the as-joined first and second tubes.

Prior to the welding or joining process, the first and second tube-holding assemblies (and more particularly, tube-receiving cavities of the first and second tube-holding assembly) need to be substantially aligned (along each axis) to ensure that complete welds are provided between axially aligned sections of tubing. Often the first and second tube-holding assemblies are aligned by inserting one or more shims between a portion of one or both of the first and second tube-holding assemblies and a respective mounting block. Alignment using the one or more shims is often time communing and complex. Further, the first and second tube-holding assemblies often include tube-receiving surfaces that extend a substantial portion of the width of the respective first and second tube-holding assemblies. Although such a configuration provides a distributed clamp force, such first and second tube-holding assemblies often do not allow for short tubing welds. Accordingly, it would be desirable to develop assemblies that reduce instances of dealignment while, alternatively or additionally, allowing for shorter tube welds, and also methods of preparing and using the same.

### SUMMARY

This section provides a general summary of the disclosure and is not a comprehensive disclosure of its full scope or all of its features.

In various aspects, the present disclosure provides an example tube clamp arrangement for a tube welding device for joining two tubes.

In at least one example embodiment, the tube clamp arrangement may include a first mounting plate and a second mounting plate, where the first mounting plate may be configured to join together a first tube-holding assembly and a first adjustment mechanism, and the second mounting plate may be configured to join together a second tube-holding assembly and a second adjustment mechanism. The first adjustment mechanism may be configured to move in a first direction in a first plane. The second adjustment mechanism may be configured to move in a second direction in the first plane.

In at least one example embodiment, the first adjustment mechanism may be configured to move the first mounting plate and the first tube-holding assembly joined thereto in a first direction.

In at least one example embodiment, the first adjustment mechanism may include a linear slide coupled to and movable along at least a portion of a rail.

In at least one example embodiment, the tube clamp arrangement may include a track configured to receive the rail, the track extending in the first direction.

In at least one example embodiment, the first mounting plate may be movably coupled to a first level arm and the first adjustment mechanism may include a first adjustment screw that extends through the first mounting plate and contacts a first end of a first level arm, where movement of the first adjustment screw may adjust a pressure as applied to the first level arm.

In at least one example embodiment, a second end of the first level arm may include a first projection and a first coupler including a first spring that couples together the first projection and an end of the first mounting plate away from the first adjustment screw.

In at least one example embodiment, the second end of the first level arm may be also pivotably coupled to a first cam that is coupled to a second spring, where the second spring may be configured to help maintain contact between the first level arm and the first adjustment screw.

In at least one example embodiment, the second adjustment mechanism may be configured to move the second mounting plate and the second tube-holding assembly joined thereto in a second direction that is different from the first direction.

In at least one example embodiment, the second adjustment mechanism may include a linear slide coupled to and moveable along at least a portion of a rail.

In at least one example embodiment, the tube clamp arrangement may include a track configured to receive the rail, the track extending in the second direction.

In at least one example embodiment, the second direction may be substantially perpendicular to the first direction.

In at least one example embodiment, the tube clamp arrangement may include a frame, and the first adjustment mechanism and the second adjustment mechanism may be each fixed on the frame.

In at least one example embodiment, the second mounting plate may be movably coupled to a second level arm, the second adjustment mechanism may include a second adjustment screw that extends through the second mounting plate and contacts a first end of the second level arm, where movement of the second adjustment screw may adjust a pressure as applied to the second level arm.

In at least one example embodiment, a second end of the second level arm may include a second projection and a second coupler including a third spring couples the second projection and an end of the second mounting plate away from the second adjustment screw.

In at least one example embodiment, the second end of the second level arm may also be pivotably coupled to a third level arm that is coupled to a fourth spring and the fourth spring may be configured to help maintain contact between the second level arm and the second adjustment screw.

In various aspects, the present disclosure provides another example tube clamp arrangement for a tube welding device for joining two tubes.

In at least one example embodiment, the tube clamp arrangement may include a frame, a first assembly, and a second assembly. The first assembly may include a first mounting plate supported by the frame and configured to join together a first tube-holding assembly and a first adjustment mechanism, the first adjustment mechanism configured to move in a first direction in a first plane. The first assembly may also include a first level arm movably coupled to the first mounting plate and a first adjustment screw that extends through the first mounting plate and contacting a first end of the first level arm, where movement of the first adjustment screw may adjust a pressure as applied to the first level arm and a position of the first mounting plate. The second assembly may include a second mounting plate supported by the frame and configured to join together a second tube-holding assembly and a second adjustment mechanism, the second adjustment mechanism configured to move in a second direction in the first plane. The second assembly may also include a second level arm movable coupled to the second mounting plate and a second adjustment screw that extends through the second mounting plate and contacting a first end of the second level arm, where movement of the second adjustment screw may adjust a pressure as applied to the second level arm and a position of the second mounting plate.

In at least one example embodiment, the first adjustment mechanism may include a first linear slide coupled to and movable along at least a portion of a first rail, and the tube clamp arrangement may include a track configured to receive the rail, the track extending in the first direction.

In at least one example embodiment, the second adjustment mechanism may include a linear slide coupled to and moveable along at least a portion of a rail, and the tube clamp arrangement may include a track configured to receive the rail, the track extending in the second direction.

In at least one example embodiment a second end of the first level arm may include a first projection and a first coupler including a first spring that couples together the first projection and an end of the first mounting plate away from the first adjustment screw, and the second end of the first level arm may be also pivotably coupled to a first cam that is coupled to a second spring, the second spring configured to help maintain contact between the first level arm and the first adjustment screw.

In at least one example embodiment a second end of the second level arm may include a second projection and wherein a second coupler including a third spring couples the second projection and an end of the second mounting plate away from the second adjustment screw, and the second end of the second level arm may also be pivotably coupled to a third level arm that is coupled to a fourth spring, the fourth spring configured to help maintain contact between the second level arm and the second adjustment screw.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a perspective view of an example tube welding device including a tube clamp arrangement that has a first tube-holding assembly and a second tube-holding assembly in accordance with at least one example embodiment of the present disclosure;

FIG. 1B is a perspective view of the example tube welding device illustrated in FIG. 1A where the first and second tube-holding assemblies are in open positions in accordance with at least one example embodiment of the present disclosure;

FIG. 1C is a perspective view of the example tube welding device of FIG. 1B where the first and second tube-holding assemblies each receives a portion of a first tube and a portion of a second tube in accordance with at least one example embodiment of the present disclosure;

FIG. 1D is a simplified illustration of the movement of the first and second tube-holding assemblies as illustrated in FIGS. 1A-1C in accordance with at least one example embodiment of the present disclosure;

FIG. 2A is a perspective view of an example tube clamp arrangement for use within a tube welding device (like the example tube welding device illustrated in FIGS. 1A-1D) where the tube clamp arrangement includes a first tube-holding assembly and a second tube-holding assembly, the first tube-holding assembly is in communication with a first adjustment mechanism, and the second tube-holding assembly is in communication with a second adjustment mechanism, in accordance with at least one example embodiment of the present disclosure;

FIG. 2B is a top-down view of the example tube clamp arrangement illustrated in FIG. 2A, where the first and second tube-holding assemblies are in a closed position in accordance with at least one example embodiment of the present disclosure;

FIG. 2C is top-down view of the example tube clamp arrangement of FIG. 2B where the first and second tube-holding assemblies are in an open position in accordance with at least one example embodiment of the present disclosure;

FIG. 2D is an exploded view of a portion of the tube clamp arrangement illustrated in FIGS. 2A-2C in accordance with at least one example embodiment of the present disclosure;

FIG. 2E is a perspective view of the example tube clamp arrangement illustrated in FIGS. 2A-2C where the first and second tube-holding assemblies and first and second mounting plates connecting the first and second tube-holding assemblies to the respective first and second adjustment mechanisms are removed for illustrate purposes;

FIG. 2F is a top-down view of the example tube clamp arrangement illustrated in FIGS. 2A-2C where the first and second tube-holding assemblies, but not the first and second mounting plates connecting the first and second tube-holding assemblies to the respective first and second tube-holding assemblies, are removed for illustrate purposes;

FIG. 3A is a side view of a portion of a first adjustment mechanism (like the first adjustment mechanism illustrated in FIGS. 2A-2F) in a first position in accordance with at least one example embodiment of the present disclosure;

FIG. 3B is a side view of the portion of the first adjustment mechanism illustrated in FIG. 3A in a second position in accordance with at least one example embodiment of the present disclosure;

FIG. 3C is a side view of the portion of the first adjustment mechanism illustrated in FIGS. 3A and 3B in a third position in accordance with at least one example embodiment of the present disclosure;

FIG. 4A is a side view of a portion of a second adjustment mechanism (like the second adjustment mechanism illustrated in FIGS. 2A-2F) in a first position in accordance with at least one example embodiment of the present disclosure;

FIG. 4B is a side view of the portion of the second adjustment mechanism illustrated in FIG. 4A in a second position in accordance with at least one example embodiment of the present disclosure; and

FIG. 4C is a side view of the portion of the second adjustment mechanism illustrated in FIGS. 4A and 4B in a third position in accordance with at least one example embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments will now be described more fully with reference to the accompanying drawings.

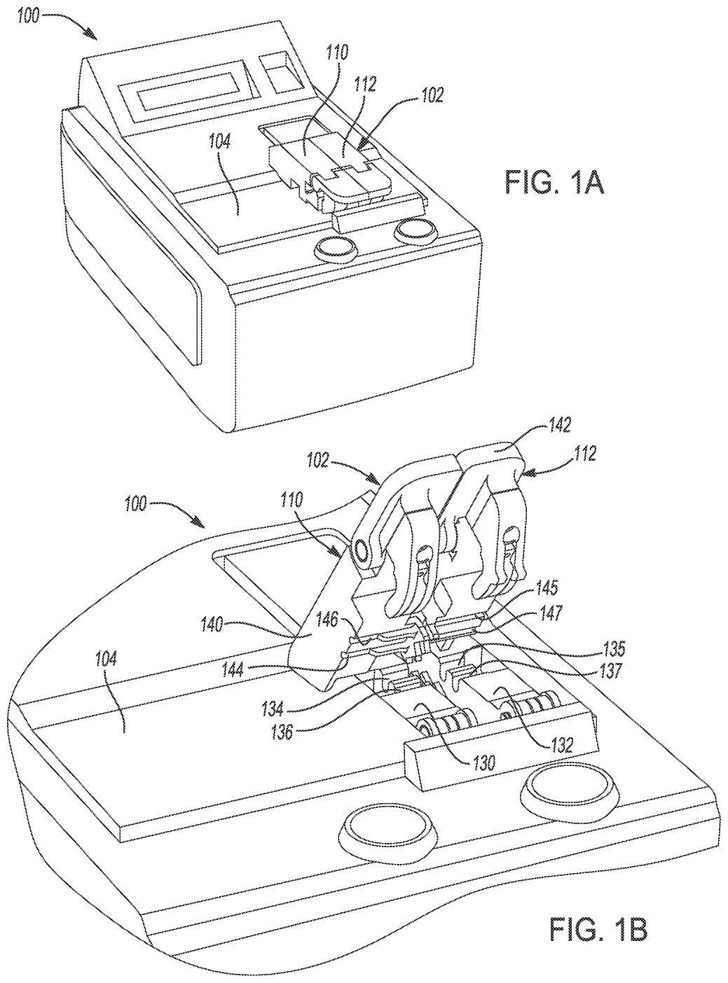

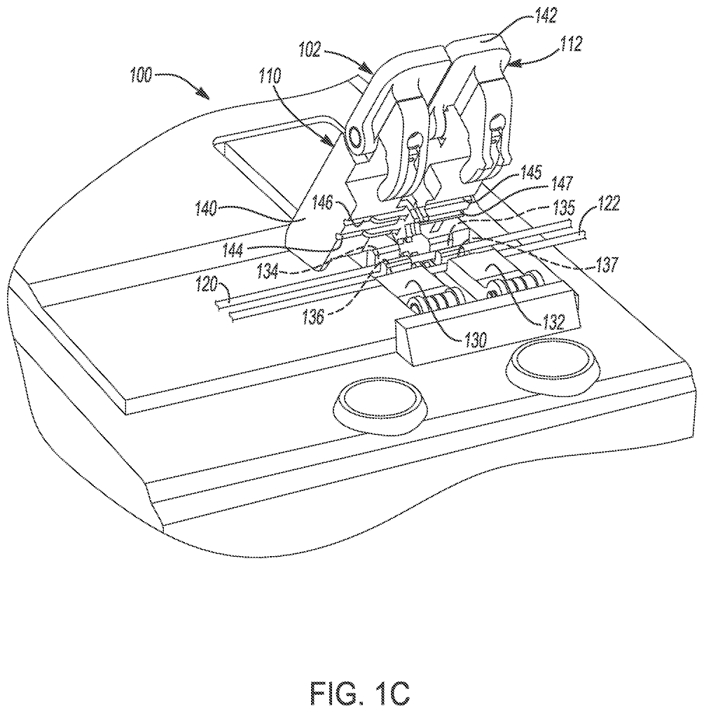

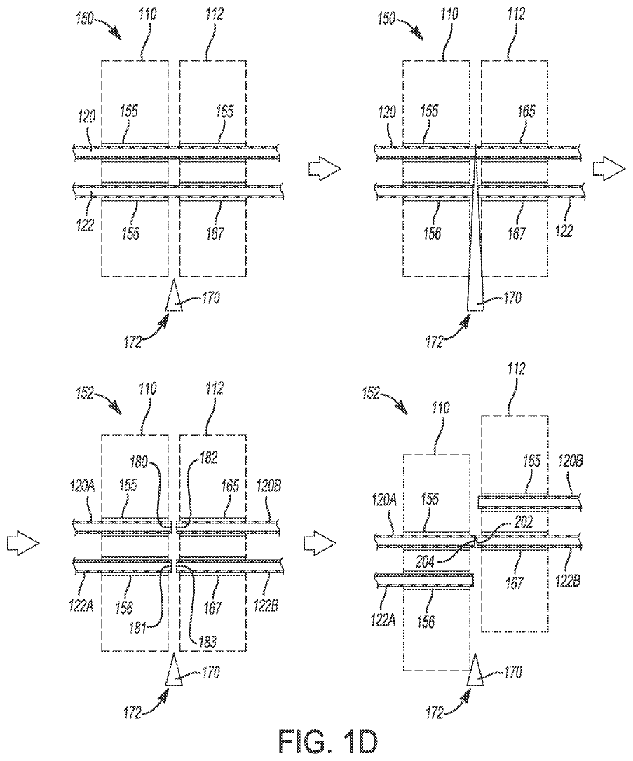

An example tube welding device (also referred to as a tube-joining machine) 100 is illustrated in FIGS. 1A-1D. The tube welding device 100 includes a tube clamp arrangement 102 that is configured to receive at least a portion of a first tube 120 and at least a portion of a second tube 122. The first and second tubes 120, 122 may be connected to bags or similar containers carrying, for example, blood or blood components. In at least one example embodiment, the tube clamp arrangement 102 includes a first tube-holding assembly (which may also be referred to as a first tube-receiving assembly) 110 that may be disposed adjacent to a second tube-holding assembly (also may also be referred to as a second tube-receiving assembly) 112. In at least one example embodiment, the first tube-holding assembly 110 may be a first tube-holding clamp, and the second tube-holding assembly 112 may be a second tube-holding clamp.

In at least one example embodiment, the first tube-holding assembly 110 may include a first or bottom clamp portion (which may also be referred to as a bottom portion) 130 and a second or top clamp portion (which may also be referred to as a top portion) 140. The bottom clamp portion 130 of the first tube-holding assembly 110 may be coupled to the top clamp portion 140 of the first tube-holding assembly 110, such that the first tube-holding assembly 110 may move between a closed position to an open position via the coupling. For example, the bottom clamp portion 130 of the first tube-holding assembly 110 may be fixedly secured to a major plane 104 of the tube welding device 100 and a top clamp portion 140 may be movable between a first (or closed) clamp state as illustrated, for example, in FIG. 1A and a second (or open) clamp state as illustrated, for example, in FIG. 1B. In at least one example embodiment, the bottom clamp portion 130 of the first tube-holding assembly 110 may be hingedly coupled to the top clamp portion 140 of the first tube-holding assembly 110.

Similarly, in at least one example embodiment, the second tube-holding assembly 112 may include a first or bottom clamp portion (which may also be referred to as a bottom portion) 132 and a second or top clamp portion (which may also be referred to as a top portion) 142. The bottom clamp portion 132 of the second tube-holding assembly 112 may be coupled to the top clamp portion 142 of the second tube-holding assembly 112, such that the second tube-holding assembly 112 may move between a closed position to an open position via the coupling. For example, the bottom clamp portion 132 of the second tube-holding assembly 112 may be fixedly secured to a major surface 104 of the tube welding device 100 and a top clamp portion 142 may be movable between a first (or closed) clamp state as illustrated in FIG. 1A and a second (or open) clamp state as illustrated in FIG. 1B. In at least one example embodiment, the bottom clamp portion 132 of the second tube-holding assembly 112 may be hingedly coupled to the top clamp portion 142 of the second tube-holding assembly 112.

The first and second tube-holding assemblies 110, 112 may each be configured to receive at least a portion of first and second tubes 120, 122. In at least one example embodiment, for example as illustrated in FIGS. 1B and 1C, the bottom clamp portion 130 of the first tube-holding assembly 110 may include a first tube-receiving crevice or recess or surface 134 configured to receive or engage a first portion of the first tube 120 and a second tube-receiving crevice or recess or surface 136 configured to receive or engage a first portion of the second tube 122. Similarly, the top clamp portion 140 of the first tube-holding assembly 110 may include a first tube-receiving crevice or recess or surface 144 also configured to receive or engage the first portion of the first tube 120 and a second tube-receiving crevice or recess or surface 146 also configured to receive or engage the first portion of the second tube 122. For example, the first tube-receiving crevice 134 of the bottom clamp portion 130 of the first tube-holding assembly 110 may align with the first tube-receiving crevice 144 of the top clamp portion 140 of the first tube-holding assembly 110 to form a first tube-receiving cavity 155 (when the first tube-holding assembly 110 is in a closed state, as illustrated, for example, in FIG. 1A). Likewise, the second tube-receiving crevice 136 of the bottom clamp portion 130 of the first tube-holding assembly 110 may align with the second tube-receiving crevice 146 of the bottom clamp portion 130 of the first tube-holding assembly 110 to form a second tube-receiving cavity 156 (when the first tube-holding assembly 110 is in a closed state, as illustrated, for example, in FIG. 1A).

Like the bottom clamp portion 130 of the first tube-holding assembly 110, the bottom clamp portion 132 of the second tube-holding assembly 112 may include a first tube-receiving crevice or recess or surface 135 configured to receive or engage a second portion of the first tube 120 and a second tube-receiving crevice or recess or surface 137 configured to receive or engage a second portion of the second tube 122. Like the top clamp portion 140 of the first tube-holding assembly 110, the top clamp portion 142 of the second tube-holding assembly 112 may include a first tube-receiving crevice or recess or surface 145 also configured to receive or engage the second portion of the first tube 120 and a second tube-receiving crevice or recess or surface 147 also configured to receive or engage the second portion of the second tube 122. For example, the first tube-receiving crevice 135 of the bottom clamp portion 132 of the second tube-holding assembly 112 may align with the first tube-receiving crevice 145 of the top clamp portion 142 of the second tube-holding assembly 112 to form a third tube-receiving cavity 165 (when the second tube-holding assembly 112 is in a closed state, as illustrated, for example, in FIG. 1A). Likewise, the second tube-receiving crevice 137 of the bottom clamp portion 132 of the second tube-holding assembly 112 may align with the second tube-receiving crevice 147 of the top clamp portion 142 of the second tube-holding assembly 112 to form a fourth tube-receiving cavity 167 (when the second tube-holding assembly 112 is in a closed state, as illustrated, for example, in FIG. 1A).

The tube welding device 100 may be configured to move one or more portions of the first tube-holding assembly 110 and/or one or more portions of the second tube-holding assembly 112. In at least one example embodiment, the tube welding device 100 may include one or more motorized mechanisms for moving the one or more portions of the first tube-holding assembly 110 and/or one or more portions of the second tube-holding assembly 112. For example, as detailed in the Atty. Docket No. 18955-000205-US-PS1, titled AUTOMATIC WELD/RESET MOTION OF CLAMPS AFTER CLAMP CLOSING/OPENING AND TUBE REMOVAL and listing James Ladtkow as inventor, filed Mar. 30, 2023 and assigned U.S. App. No. 63/455,873, the entire contents of which are herein incorporated by reference.

In at least one example embodiment, the one or more portions of the first tube-holding assembly 110 and/or the one or more portions of the second tube-holding assembly 112 may be movable in a first direction along a major axis of the tube welding machine 100 and/or a second direction along a minor axis of the tube welding machine 100. In at least one example embodiment, for example as illustrated FIG. 1D, the one or more portions of the first tube-holding assembly 110 and one or more portions of the second tube-holding assembly 112 may both be in a first or initial position 150 such that the first tube-receiving cavity 155 of the first tube-holding assembly 110 is aligned with the third tube-receiving cavity 165 of the second tube-holding assembly 112 and the second tube-receiving cavity 156 of the first tube-holding assembly 110 is aligned with the fourth tube-receiving cavity 167 of the second tube-holding assembly 112.

In the initial position 150, the first tube-receiving cavity 155 of the first tube-holding assembly 110 and the third tube-receiving cavity 165 of the second tube-holding assembly 112 aligned therewith may receive adjoining portions of the first tube 120, and the second tube-receiving cavity 156 of the first tube-holding assembly 110 and the fourth tube-receiving cavity 167 of the second tube-holding assembly 112 aligned therewith may receive adjoining portions of the second tube 122, as illustrated for example, in FIGS. 1C and 1D. In at least one example embodiment, the one or more portions of the first tube-holding assembly 110 may be movable relative to the one or more portions of the second tube-holding assembly 112 and/or the one or more portions of the second tube-holding assembly 112 may be movable relative to the one or more portions of the first tube-holding assembly 114, such that, as illustrated in FIG. 1D, a second position 152 is defined, where the first tube-receiving cavity 155 of the first tube-holding assembly 110 is aligned with the third tube-receiving cavity 165 of the second tube-holding assembly 112.

In at least one example embodiment, the tube welding device 100 is configured to receive a wafer 170 within a gap or space between the first tube-holding assembly 110 and the second tube-holding assembly 112. In at least one example embodiment, for example, as illustrated best in FIG. 1D, when the first tube-holding assembly 110 and the second tube-holding assembly 112 are aligned in the initial position 150, the tube welding device 100 may be configured to send energy to the wafer 170 to heat the wafer to a desired temperature (i.e., a tube-joining temperature) and to move the heated wafer 170 from a first non-contact position 172 to a second contact position 174 where the wafer 170 contacts the first and second tubes 120, 122 to temporarily seal together opposing surface of the respective tubes 120, 122 while splitting the tubes into first and second halves 120A, 120B, 122A, 122B and creating molten tube ends (including, for example, first and second molten tube ends 180, 182 for the first tube 120 and first and second molten tube ends 181, 183 for the second tube 122). For example, the heated wafer 170 may cause the portions of the tubes 120, 122 contacted to melt.

In at least one example embodiment, the wafer 170 may be heated using a radiant or conductive heat source the is configured to heat the wafer 170 based on instructions received form a controller. Alternatively, or additionally, the wafer 170 may include an embedded resistive heating element (not shown) and the tube-joining device 100 may be configured to supply an electric current to the embedded resistive heating element based on an instruction received from the controller. In at least one example embodiment, the wafer 170 includes a conductive material, like copper. In at least one example embodiment, the wafer 170 may be a replaceable wafer. For example, the wafer 170 may be removed and replaced after selected use.

In at least one example embodiment, the tube welding device 100 may include an actuator that is in communication with the controller and that is configured to move the wafer 170 between the first non-contact position 172 and the second contact position 174. After the heated wafer 170 is contacted to the first and/or second tubes 120, 122 (i.e., after the welding event and formation of the molten tube ends 180, 181, 182, 183), the wafer 170 may be displaced—for example, returned to its first non-contact position 172 (i.e., retracted)—and the tube welding device 100, as discussed above, may be configured to move the one or more portions of the first tube-holding assembly 110 and/or the one or more portions of the second tube-holding assembly 112 to the second position 152 such that the first molten tube end 180 of the first tube 120 is brought into contact with the second molten tube end 183 of the second tube 122 (and/or the second molten tube end 183 of the second tube 122 is brought into contact with the first molten 180 of the first tube 120) to form a jointed tube. In at least one example embodiment, the jointed tube 200 may be cooled (for example, passively to room temperature, which is often between about 20° C. and about 22° C.) and subjected to a stress that breaks the temporary seals of the molten tube ends 180, 183 opening the lumen providing fluid communication between the as-joined first and second tubes. Methods for applying the stress are illustrated, for example, in Atty. Docket No. 18955-000215-US-PS1, titled SYSTEMS FOR AUTOMATIC OPENING OF WELDED TUBES and listing Dennis Bebie, James Ladtkow, and Charles Hake as inventors, filed Mar. 30, 2023 and assigned U.S. App. No. 63/455,840, the entire contents of which are herein incorporated by reference.

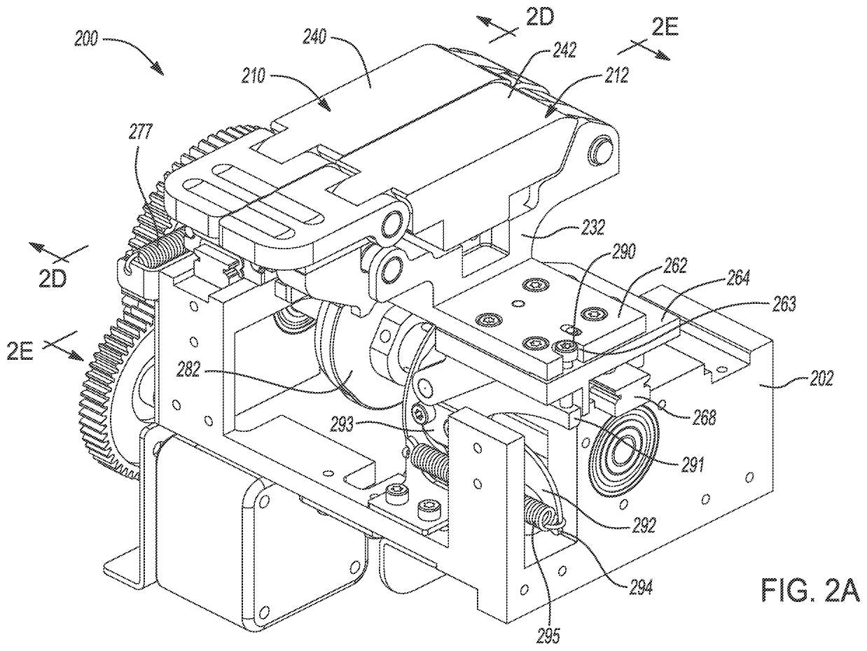

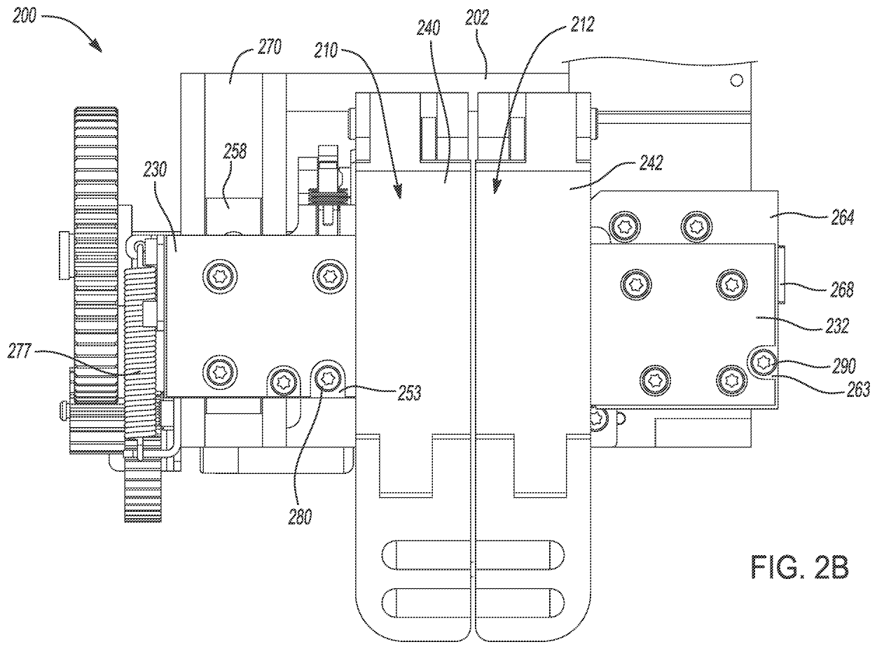

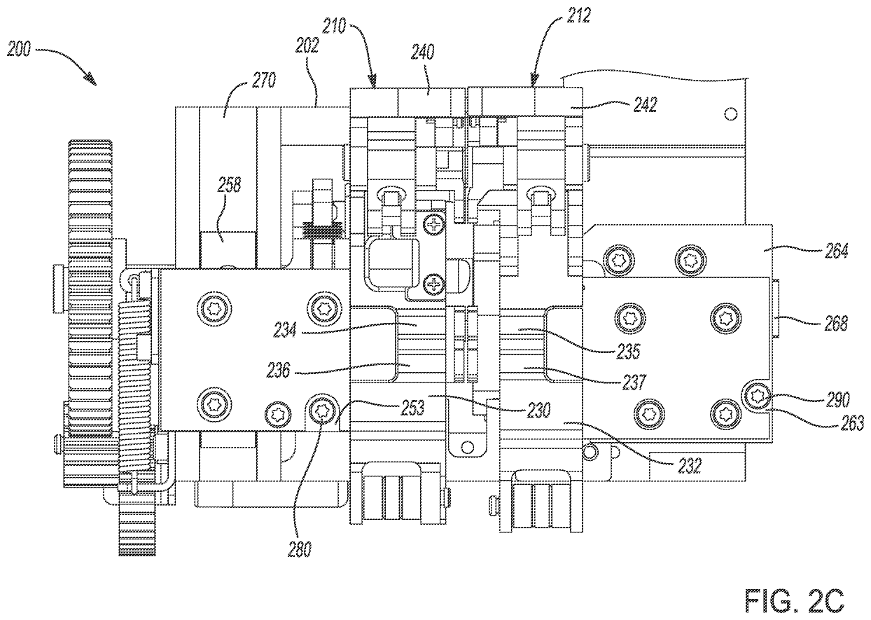

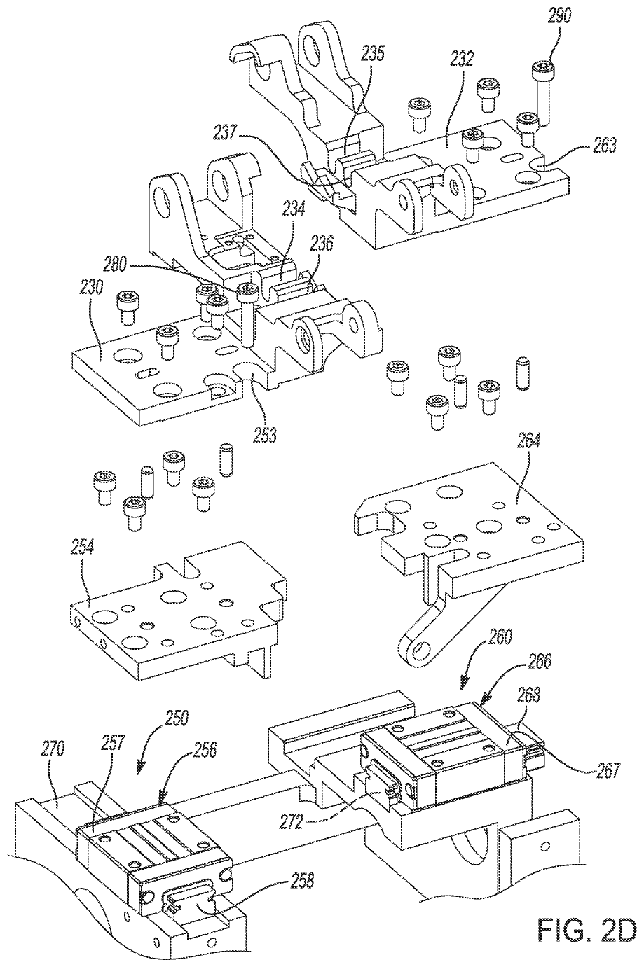

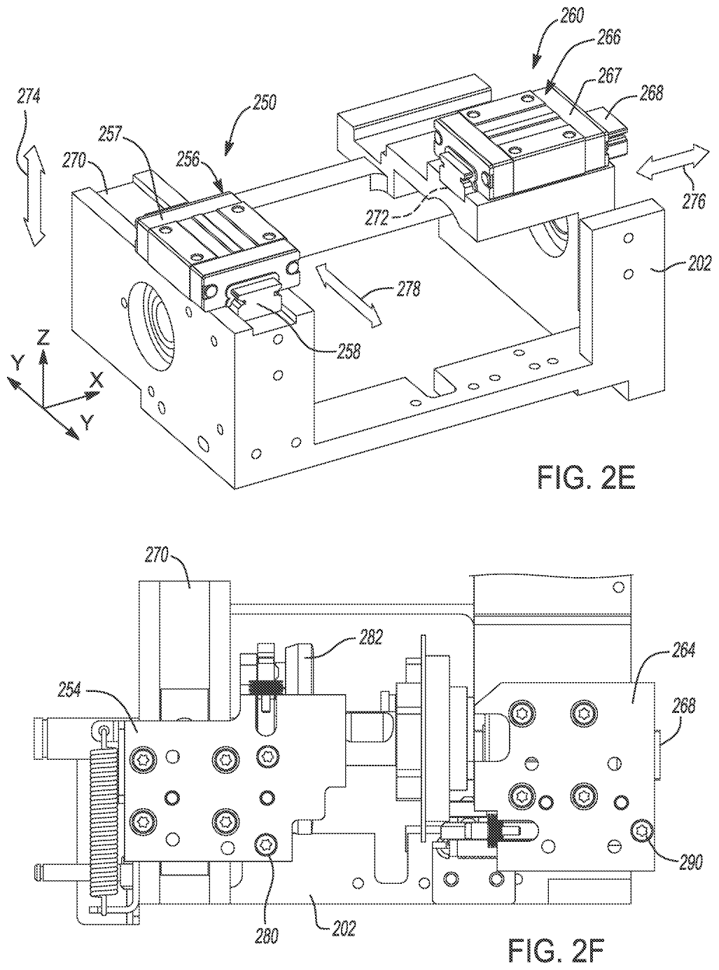

Prior to a welding or joining process (for example, as illustrated in FIG. 1D) first and second tube-holding assemblies (and more particularly, tube-receiving cavities of the first and second tube-holding assembly) need to be substantially aligned (along each axis) to ensure that complete welds are provided between axially aligned sections of tubing (e.g., between the first molten tube end 180 of the first tube 120 and the second molten tube end 183 of the second tube 122). FIGS. 2A-2F illustrate an example tube clamp arrangement 200 that includes a first tube-holding assembly 210 and a second tube-holding assembly 112, where the first tube-holding assembly 210 is in communication with a first adjustment mechanism 250 and the second tube-holding assembly 212 is in communication with a second adjustment mechanism 260 for use within a tube welding device 100 (like the example tube welding device illustrated in FIGS. 1A-1D) in accordance with at least one example embodiment of the present disclosure. The tube clamp arrangement 200 may be used as the tube clamp arrangement 102 illustrated in FIGS. 1A-1D.

In at least one example embodiment, the first and second tube-holding assemblies 210, 212 may be the same as the first and second tube-holding assemblies 110, 112 illustrated in FIGS. 1A-1D. For example, the first tube-holding assembly 210 may include a first or bottom clamp portion (which may also be referred to as a bottom portion) 230 movably (e.g., hingedly) coupled to a second or top clamp portion (which may also be referred to as a top portion) 240, where the bottom clamp portion 230 includes first and second first tube-receiving crevices or recesses or surface 234, 236 configured to receive or engage a first portion of a first tube and a first portion of a second tube, respectively, and the top clamp portion 240 includes third and fourth tube-receiving crevices or recesses or surfaces 244, 246 also configured to receive the first portion of the first tube and the first portion of the second tube, respectively. Similarly, the tube-holding assembly 212 may include a first or bottom clamp portion (which may also be referred to as a bottom portion) 232 movably (e.g., hingedly) coupled to a second or top clamp portion (which may also be referred to as a top portion) 242, where the bottom clamp portion 232 includes first and second tube-receiving crevices or recesses or surfaces 235, 237 configured to receive a second portion of the first tube and a second portion of the second tube, respectively, and the top clamp portion 242 includes third and fourth tube-receiving crevices or recesses or surfaces 245, 247 also configured to receive the second portion of the first tube and the second portion of the second tube, respectively.

In at least one example embodiment, the bottom clamp portion 230 of the first tube-holding assembly 210 may be mounted to or on a first adjustment mechanism 250. The first adjustment mechanism 250 may be configured to move and position the first tube-holding assembly 210 along a first rail 258. As best illustrated, for example, in FIG. 2E, the first tube-holding assembly 210 may be coupled to the first adjustment mechanism 250 via a first mounting plate 254. In at least one example embodiment, the bottom clamp portion 230 of the first tube-holding assembly 210 may include a first plate that is brought into parallel alignment with the first mounting plate 254 and also a first linear slide 256 of the first adjustment mechanism 250. The first linear slide 256 may be couplable to and movable along at least a portion of the first rail 258. In at least one example embodiment, the first linear slide 256 may cover a portion of the first rail 258. In at least one example embodiment, the first rail 258 may extend in a first direction 278 along a frame (also referred to as a datum) 202 of the tube clamp arrangement 200. In at least one example embodiment, the first rail 258 may be received within and fixed to a first track or recess 270. The first rail 258 may extend along an entire length of the first track 270 or a portion thereof.

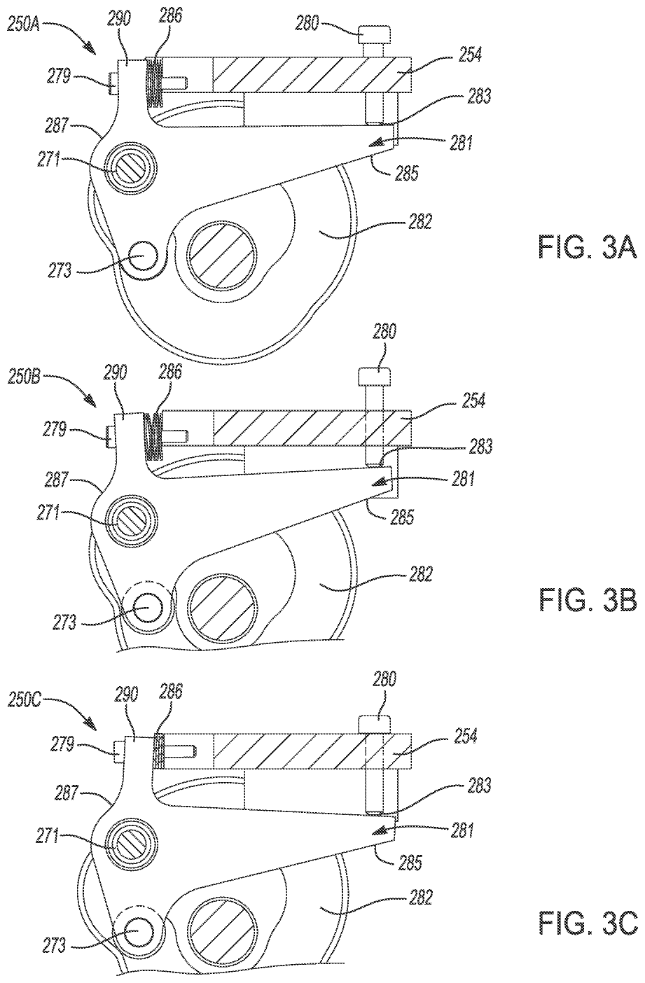

In at least one example embodiment, the first adjustment mechanism 250 may include a first adjustment screw 280 that is received by the first mounting plate 254. The bottom clamp portion 230 of the first tube-holding assembly 210 may include a recess or alcove 253 through which the first adjustment screw 280 extends but to which the first adjustment screw 280 is not coupled to, or otherwise received by, the bottom clamp portion 230 of the first tube-holding assembly 210. In at least one example embodiment, for example as illustrated in FIGS. 3A-3C, the first adjustment screw 280 may be movable between a first or neutral position 250A (see FIG. 3A) and a second or extended position 250B (see FIG. 3B) and/or a third or retracted position 250C (see FIG. 3C). In at least one example embodiment, the first adjustment screw 280 may be rotated (e.g., manually or automatically) in a counterclockwise position to move the first adjustment screw 280 from the first position 250A to the second position 250B. In at least one example embodiment, the first adjustment screw 280 may be rotated (e.g., manually or automatically) in a clockwise position to move the first adjustment screw 280 from the first position 250A to the third position 250C.

In at least one example embodiment, a distal end 283 of the first adjustment screw 280 may be configured to contact a first end 285 of first level arm 281 that is movably coupled to a first cam 282 and the first mounting plate 254. For example, the first level arm 281 may be pivotably coupled to the first cam 282, where the hinge coupling includes a first pivot point 271 and a first cam connection (e.g., cam follower) 273. In at least one example embodiment, the first adjustment mechanism 250 may further include a first spring 277 configured to help to maintain contact between the first cam 282 and the first cam connection 273 as the first cam 282 via its connection to the first level arm 281 moves between the first, second, and third positions 250A, 250B, 250C. In at least one example embodiment, the first spring 277 may be a tension spring.

In at least one example embodiment, a second end 287 of the first level arm 281 distal to the first end 285 may be movably coupled to an end of the first mounting plate 254 away from the first adjustment screw 280. For example, the second end 287 of the first level arm 281 may include a first projection 288 and a second spring 286 may be positioned between the first projection 288 and the first mounting plate 254, where a first coupler (e.g., screw) 279 extends through the second spring 286 and connects the projection 290 and the first mounting plate 254. The second spring 286 allows the first level arm 281 to rotate with regard to the pivot point 271 and the first cam connection 273 without losing rigidity. That is, when the first adjustment screw 280 is in the first position 250A, the first mounting plate 254 (and the first tube-holding assembly 210 attached thereto) via the first level arm 281 and the second spring 286 in communication therewith may be in a first position; when the first adjustment screw 280 is in the second position 250B, the first mounting plate 254 (and the first tube-holding assembly 210 attached thereto) via the second level arm 291 and the second spring 286 in communication therewith may be in a second position that is different from the first position; and when the first adjustment screw 280 is in the third position 250C, the first mounting plate 254 (and the first tube-holding assembly 210 attached thereto) via the second level arm 291 and the second spring 286 in communication therewith may be in a third position that is different from both the first and second positions.

In at least one example embodiment, when the first adjustment screw 280 is in the first position 250A, the first level arm 281 and the cam 282 may also be in first positions; when the first adjustment screw 280 is in the second position 250B, the first level arm 281 and the first cam 282 may also be in second positions; and when the first adjustment screw 280 is in the third position 250C, the first level arm 281 and the first cam 282 may also be in third positions. For example, when the first adjustment screw 280 is in the first position 250A, the first adjustment screw 280 may be configured to apply a first pressure to the first level arm 281 and in turn a first pressure to the first cam 282 and a first pressure to the second spring 286 to maintain the first level arm 281, the first cam 282, and the first mounting plate 254 in first positions (see FIG. 3A); when the first adjustment screw 280 is in the second position 250B, the first adjustment screw 280 may be configured to release a certain pressure form the first level arm 281 and in turn the first cam 282 and the second spring 286 such that the first level arm 281, the first cam 282, and the first mounting plate 254 are in second positions (see FIG. 3B); and when the first adjustment screw 280 is in the third position 250C, the first adjustment screw 280 may be configured to apply a second pressure to the first level arm 281 and in turn a second pressure to the first cam 282 and a second pressure to the second spring 286 to maintain the first level arm 281, the first cam 282, and the first mounting plate 254 in third positions (see FIG. 3C).

Although only three position are illustrated and discussed, it should be appreciated that, in various other example embodiments, using this configuration the first adjustment screw 280 may be configured to move the first level arm 281 and the first mounting plate 254 to a variety of configurations between a fully extended position of the first adjustment screw 280 and a fully retracted position of the first adjustment screw 280, allowing for incremental adjustments of the first mounting plate 254 and the first tube-holding assembly 210 attached thereto.

In at least one example embodiment, the bottom clamp portion 232 of the second tube-holding assembly 212 may be mounted to or on a second adjustment mechanism 260. The second adjustment mechanism 260 may be configured to move and position the second tube-holding assembly 212 along a second rail 268. As best illustrated, for example, in FIG. 2E, the second tube-holding assembly 212 may be coupled to the second adjustment mechanism 160 via a second mounting plate 264. In at least one example embodiment, the bottom clamp portion 232 of the second tube-holding assembly 212 may include a second plate that is brought into parallel alignment with the second mounting plate 264 and also a second linear slide 266 of the second adjustment mechanism 260. The second linear slide 266 may be couplable to and movable along at least a portion of the second rail 268. In at least one example embodiment, the second linear slide 266 may cover a portion of the second rail 268. In at least one example embodiment, the second rail 268 may extend in a second direction 276 along a frame (also referred to as a datum) 202 of the tube clamp arrangement 200. The second direction 276 may be different from the first direction 278. For example, the first direction 278 may be along a y-axis of the frame 202, while the second direction 278 may be along an x-axis of the frame 202—that is, the second direction 276 may be substantially perpendicular to the first direction 278. Because both the first and second tube-holding assemblies 210, 212 are each mounted to a common reference surface (i.e.. the frame 202), and movable in a fixed plane defined by the y-axis 278 and the x-axis 276, the alignment of the first and second tube-holding assemblies 210, 212 are dependent only on the tolerances of the individual clamps, eliminating the need for shimming in the third direction (i.e., along a z-axis 274). In at least one example embodiment, the second rail 268 may be received within and fixed to a second track or recess 272. The second rail 268 may extend along an entire length of the second track 272 or a portion thereof.

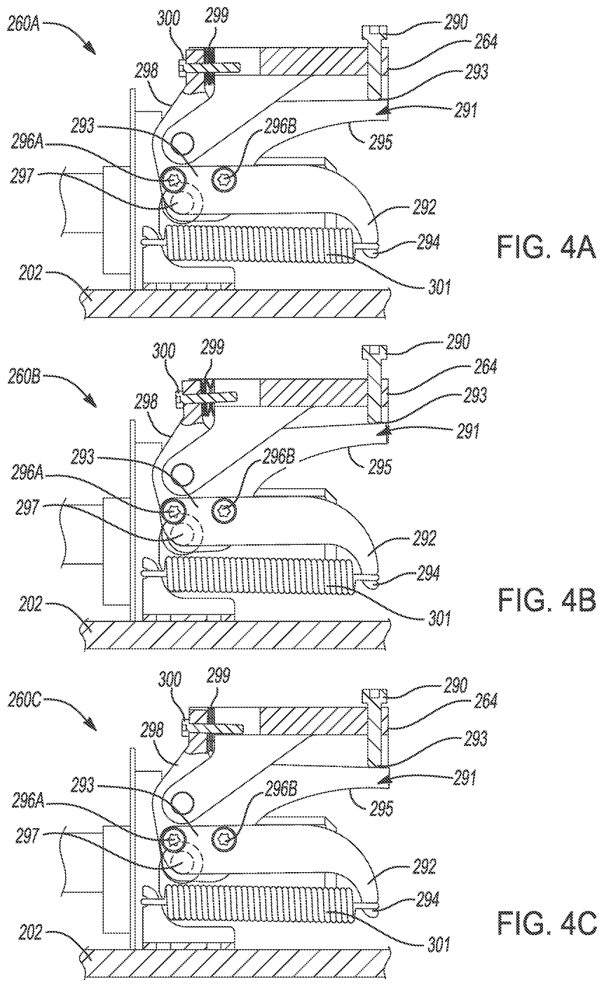

In at least one example embodiment, the second adjustment mechanism 260 may include a second adjustment screw 290 that is received by the second mounting plate 264. The bottom clamp portion 232 of the second tube-holding assembly 212 may include a recess or alcove 263 through which the second adjustment screw 290 extends but to which the second adjustment screw 290 is not coupled to, or otherwise received by, the bottom clamp portion 232 of the first tube-holding assembly 212. In at least one example embodiment, for example as illustrated in FIGS. 4A-4C, the second adjustment screw 290 may be movable between a first or neutral position 260A (see FIG. 3A) and a second or extended position 260B (see FIG. 3B) and/or a third or retracted position 260C (see FIG. 3C). In at least one example embodiment, the second adjustment screw 290 may be rotated (e.g., manually or automatically) in a counterclockwise position to move the second adjustment screw 290 form the first position 260A to the second position 260B. In at least one example embodiment, the second adjustment screw 290 may be rotated (e.g., manually or automatically) in a clockwise position to move the second adjustment screw 290 from the first position 260A to the third position 260C.

In at least one example embodiment, a distal end 298 of the second adjustment screw 290 may be configured to contact a first end 295 of a second level arm 291 that is movable couplable to a third level arm 292. For example, the second level arm 291 may be hingedly coupled to the third level arm 292, where the hinged coupling includes, for example, one or more pivot points 296A, 296B and a cam follower 297. In at least one example embodiment, when the second adjustment screw 290 is in the first position 260A, the second level arm 291 and also the third level arm 292 via its connection to the second level arm 291 may be in first positions (see FIG. 4A); when the second adjustment screw 290 is in the second position 260B, the second level arm 291 and also the third level arm 292 via its connection to the second level arm 291 may be in second positions (see FIG. 4B); and when the second adjustment screw 290 is in the third position 260B, the second level arm 291 and also the third level arm 292 via its connection to the second level arm 291 may be in third positions (see FIG. 4C). In at least one example embodiment, the third level arm 292 may have a first end 293 and a second end 294 separated therefrom. As discussed, the first end 293 of the third level arm 292 may be pivotally coupled to the second level arm 291. The second end 294 of the third level arm may be coupled to a third spring 301 that is configured to help to maintain contact between the second level arm 291 and the second adjustment screw 290 as the second adjustment mechanism 260 moves between the first position 260A, the second position 260B, and the third position 260C. In at least one example embodiment, the third spring 301 may be tension spring.

In at least one example embodiment, a second end 298 of the second level arm 291 distal to the first end 295 may be movably coupled to an end of the second mounting plate 264 away from the second adjustment screw 290. For example, the second end 298 of the second level arm 291 may include a second projection 298 and a fourth spring 299 may be positioned between the second projection 298 and the second mounting plate 264, where a second coupler (e.g., screw) 300 extends through the fourth spring 299 and connects the second projection 299 and the second mounting plate 264. The fourth spring 299 allows the second level arm 291 to rotate with regard to the pivot points 296A, 296B and the cam follower 297 without losing rigidity. That is, when the second adjustment screw 290 is in the first position 260A, because of the first pressure applied to the second level arm 291, the second mounting plate 264 (and the second tube-holding assembly 212 attached thereto) via the second level arm 291 and the fourth spring 299 in communication therewith may be in a first position; when the second adjustment screw 290 is in the second position 260B, the second mounting plate 264 (and the second tube-holding assembly 212 attached thereto) via the second level arm 291 and the fourth spring 299 in communication therewith may be in a second position that is different from the first position; and when the second adjustment screw 290 is in the third position 260C, the second mounting plate 264 (and the second tube-holding assembly 212 attached thereto) via the second level arm 291 and the fourth spring 299 in communication therewith may be in a third position that is different from both the first and second positions. In at least one example embodiment, the fourth spring 299 may be a disc spring.

In at least one example embodiment, when the second adjustment screw 290 is in the first position 260A, the second level arm 291 and the third level arm 292 may also be in first positions; when the second adjustment screw 290 is in the second position 260B, the second level arm 291 and the third level arm 292 may also be in second positions; and when the second adjustment screw 290 is in the third position, the second level arm 291 and the third level arm 292 may also be in third position. For example, the second adjustment screw 290 is in the first position 260A, the second adjustment screw 290 may be configured to apply a first pressure to the second level arm 291 and in turn a first pressure to the third level arm 292 and a first pressure to the third spring 299 to maintain the second level arm 291, the third level arm 292, and the second mounting plating 264 in first positions (see FIG. 4A); when the second adjustment screw 290 is in the second position 260B, the second adjustment screw 290 may be configured to release a certain pressure form the second level arm 291 and in turn the third level arm 292 and the third spring 299 such that the second level arm 291, the third level arm 292, and the second mounting plate 264 are in second positions (see FIG. 4B); and when the second adjustment screw 290 is in the third position 260C, the second adjustment screw 290 may be configured to apply a second pressure to the second level arm 291 and in turn a second pressure to the third level arm 29 and a second pressure to the spring 299 to maintain the second level arm 291, the third level arm 292, and the second mounting plate 264 in third positions (see FIG. 4C).

Although only three position are illustrated and discussed, it should be appreciated that, in various other example embodiments, using this configuration the second adjustment screw 290 may be configured to move the second level arm 291 and in turn the second mounting plate 264 to a variety of configurations between a fully extended position of the second adjustment screw 290 and a fully retracted position of the second adjustment screw 290. Thus, allowing for incremental adjustments of the second mounting plate 264 and the second tube-holding assembly 212 attached thereto. The ability for incremental adjustments permits an overall width of the tube clamp arrangement 200 to be shortened. For example, in at least one example embodiment, the tube clamp arrangement 200 may have an overall average width of about 48 millimeters, whereas by way of comparison only, convention tube clamp arrangements have an overall average width of about 68 millimeters.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tube clamp arrangement for a tube welding device for joining two tubes, the tube clamp arrangement comprising:
a first mounting plate configured to join together a first tube-holding assembly and a first adjustment mechanism, the first adjustment mechanism configured to move in a first direction in a first plane; and
a second mounting plate configured to join together a second tube-holding assembly and a second adjustment mechanism, the second adjustment mechanism configured to move in a second direction in the first plane.

2. The tube clamp arrangement of claim 1, wherein the first adjustment mechanism is configured to move the first mounting plate and the first tube-holding assembly joined thereto in a first direction.

3. The tube clamp arrangement of claim 2, wherein the first adjustment mechanism includes a linear slide coupled to and movable along at least a portion of a rail.

4. The tube clamp arrangement of claim 3, wherein the tube clamp arrangement includes a track configured to receive the rail, the track extending in the first direction.

5. The tube clamp arrangement of claim 2, wherein the first mounting plate is movably coupled to a first level arm and the first adjustment mechanism includes a first adjustment screw that extends through the first mounting plate and contacts a first end of a first level arm, wherein movement of the first adjustment screw adjusts a pressure as applied to the first level arm.

6. The tube clamp arrangement of claim 5, wherein a second end of the first level arm includes a first projection and a first coupler including a first spring that couples together the first projection and an end of the first mounting plate away from the first adjustment screw.

7. The tube clamp arrangement of claim 6, wherein the second end of the first level arm is also pivotably coupled to a first cam that is coupled to a second spring, the second spring configured to help maintain contact between the first level arm and the first adjustment screw.

8. The tube clamp arrangement of claim 2, wherein the second adjustment mechanism is configured to move the second mounting plate and the second tube-holding assembly joined thereto in a second direction that is different from the first direction.

9. The tube clamp arrangement of claim 8, wherein the second adjustment mechanism includes a linear slide coupled to and moveable along at least a portion of a rail.

10. The tube clamp arrangement of claim 9, wherein the tube clamp arrangement includes a track configured to receive the rail, the track extending in the second direction.

11. The tube clamp arrangement of claim 8, wherein the second direction is substantially perpendicular to the first direction.

12. The tube clamp arrangement of claim 8, wherein the tube clamp arrangement includes a frame, and the first adjustment mechanism and the second adjustment mechanism are each fixed on the frame.

13. The tube clamp arrangement of claim 8, wherein the second mounting plate is movably coupled to a second level arm, the second adjustment mechanism includes a second adjustment screw that extends through the second mounting plate and contacts a first end of the second level arm, wherein movement of the second adjustment screw adjusts a pressure as applied to the second level arm.

14. The tube clamp arrangement of claim 13, wherein a second end of the second level arm includes a second projection and wherein a second coupler including a third spring couples the second projection and an end of the second mounting plate away from the second adjustment screw.

15. The tube clamp arrangement of claim 14, wherein the second end of the second level arm is also pivotably coupled to a third level arm that is coupled to a fourth spring, the fourth spring configured to help maintain contact between the second level arm and the second adjustment screw.

16. A tube clamp arrangement for a tube welding device for joining two tubes, the tube clamp arrangement comprising:
a frame,
a first assembly including:
a first mounting plate supported by the frame and configured to join together a first tube-holding assembly and a first adjustment mechanism, the first adjustment mechanism configured to move in a first direction in a first plane,
a first level arm movably coupled to the first mounting plate, and
a first adjustment screw that extends through the first mounting plate and contacting a first end of the first level arm, wherein movement of the first adjustment screw adjusts a pressure as applied to the first level arm and a position of the first mounting plate; and
a second assembly including:
a second mounting plate supported by the frame and configured to join together a second tube-holding assembly and a second adjustment mechanism, the second adjustment mechanism configured to move in a second direction in the first plane,
a second level arm movable coupled to the second mounting plate, and
a second adjustment screw that extends through the second mounting plate and contacting a first end of the second level arm, wherein movement of the second adjustment screw adjusts a pressure as applied to the second level arm and a position of the second mounting plate.

17. The tube clamp arrangement of claim 16, wherein
the first adjustment mechanism includes a first linear slide coupled to and movable along at least a portion of a first rail, and
the tube clamp arrangement includes a track configured to receive the rail, the track extending in the first direction.

18. The tube clamp arrangement of claim 17, wherein
the second adjustment mechanism includes a linear slide coupled to and moveable along at least a portion of a rail, and
the tube clamp arrangement includes a track configured to receive the rail, the track extending in the second direction.

19. The tube clamp arrangement of claim 16, wherein
a second end of the first level arm includes a first projection and a first coupler including a first spring that couples together the first projection and an end of the first mounting plate away from the first adjustment screw, and
the second end of the first level arm is also pivotably coupled to a first cam that is coupled to a second spring, the second spring configured to help maintain contact between the first level arm and the first adjustment screw.

20. The clamp arrangement of claim 16, wherein
a second end of the second level arm includes a second projection and a second coupler including a third spring couples the second projection and an end of the second mounting plate away from the second adjustment screw, and
the second end of the second level arm is also pivotably coupled to a third level arm that is coupled to a fourth spring, the fourth spring configured to help maintain contact between the second level arm and the second adjustment screw.
